(19) United States
(12) Patent Application Publication
(10) Pub. No.: US 2012/0006016 A1
(43) Pub. Date: Jan. 12, 2012

(54) HYDROPNEUMATIC PISTON RESERVOIR

(75) Inventor: Walter Runkel, Leubsdorf (DE)

(73) Assignee: Hemscheidt Fahrwerktechnik GmbH & Co. KG, Haan-Gruiten (DE)

(21) Appl. No.: 12/856,041

(22) Filed: Aug. 13, 2010

(30) Foreign Application Priority Data
Jul. 6, 2010 (EP) EP 10168521.2

(51) Int. Cl. F15B 11/072; F15B 15/22; B60G 17/08

(52) U.S. Cl. 60/561

(57) ABSTRACT

This invention relates to a hydropneumatic piston reservoir (1) with a primary cylinder (2) in which runs a separating piston (12) with free mobility, with the separating piston (12) sealed off circumferentially, with the separating piston (12) inside the primary cylinder (2) separating two pressure chambers (16, 18) from one another. The separating piston (12) has an axial separating piston rod (20) at one end that is sealed off circumferentially from the primary cylinder (2) and is guided as a plunger (22) in a connected secondary cylinder (4) and is subjected to or can be subjected to a pressure medium. The plunger (22) at its free end away from the primary cylinder (2) has a bumper element (24) with a bumper area (28) projecting radially over the outer circumference (26) of the plunger (22).

### CROSS REFERENCE TO RELATED APPLICATION

This application claims priority to European Patent Application No. EP 10168521.2, filed Jul. 6, 2010.

### FIELD OF THE INVENTION

This invention relates to a hydropneumatic piston reservoir with a primary cylinder having a separating piston with free mobility that is sealed off circumferentially from an inner surface of the cylinder, with the separating piston inside the primary cylinder separating two pressure chambers from one another and being acted upon, or able to be acted on, by a pneumatic pressure medium on the one hand and by a hydraulic medium on the other hand, and with the separating piston having an axial separating piston rod on one end that is sealed circumferentially from the primary cylinder, and runs as a plunger in a connected secondary cylinder that is acted upon or can be acted upon by a pressure medium.

### BACKGROUND OF THE INVENTION

Piston reservoirs of the above described type are used in particular in suspension systems for wheel support in motor vehicles. Thus, for example, DE 195 15 295 A1 describes a hydropneumatic suspension system with each hydraulic shock absorber leg (telescopic spring cylinder) acting to produce a spring force supporting the particular wheel load through a hydraulic medium against a spring reservoir. Such a spring reservoir is designed, in this case, as a piston reservoir of the type defined above generically. The piston reservoir has a “floating,” freely movable guided separating piston that separates the reservoir chamber (first pressure chamber) hydraulically connected to the shock absorber leg from a spring chamber (second pressure chamber) containing a compressible medium, in particular a gas. The separating piston here is connected to a separating piston rod guided out of the piston reservoir to the outside. Because of this separating piston rod, the separating piston has two pressure-impacted surfaces of different sizes, so that it acts as a pressure converter in such a way that the hydraulic pressure is always greater than the pneumatic pressure. In addition, in order to control the spring characteristic, the separating piston can be impacted by an additional spring force across its separating piston rod. In the known embodiment, this added spring force is produced by a secondary cylinder acting on the separating piston rod. The separating piston rod is fed in the manner of a plunger into the secondary cylinder, so that it is impacted with a force acting toward the separating piston by admitting to it a pressure medium in the secondary cylinder, which thus acts in the direction of the force applied by the hydraulic pressure. This added spring force thus has the tendency of reducing or compressing additionally the volume of the spring chamber of the primary cylinder. In the known suspension system, the secondary reservoirs of two piston reservoirs are also connected hydraulically to a common supplementary reservoir, so that a hydraulic medium under pressure is placed inside the secondary reservoir.

The known piston reservoir has been well proved in practice so far, but under some operating conditions, the allowable maximum pressure in the primary cylinder can be exceeded, which might sometimes lead to a cylinder cap being forced out on the side facing away from the secondary cylinder. In such a failure, the entire separating piston would be catapulted out of the reservoir by the pressure in the secondary cylinder.

The problem underlying this invention is to improve the known piston reservoir with respect to its safety.

This goal is attained by the features of this invention.

The invention provides that the separating piston rod or its end area constituting the plunger has a bumper element at the free end away from the primary cylinder, with a bumper area projecting radially over the outer circumference of the plunger. If in the failure case described above, the separating piston with the plunger should be accelerated by the pressure in the secondary cylinder toward the primary cylinder, then the bumper area of the bumper element strikes a bumper surface in front of a plunger passage to the primary cylinder, so that the separating piston together with the separating piston rod and the plunger is prevented from being able to leave the reservoir like a shot. In fact, deformation damages in the bumper area will then occur, which make the piston reservoir useless thereafter, so that it has to be replaced by a new piston reservoir. However, this is acceptable in the interest of increased safety.

### BRIEF DESCRIPTION OF THE DRAWINGS

With reference to a preferred sample embodiment shown in the drawing, the invention will be described in further detail below. The Figures show:

FIG. 1 is a schematic side view of a piston reservoir pursuant to the invention with some areas cut away, and

FIG. 2 is an enlarged axial cross section of the secondary cylinder in transition to the primary cylinder.

### DETAILED DESCRIPTION OF THE INVENTION

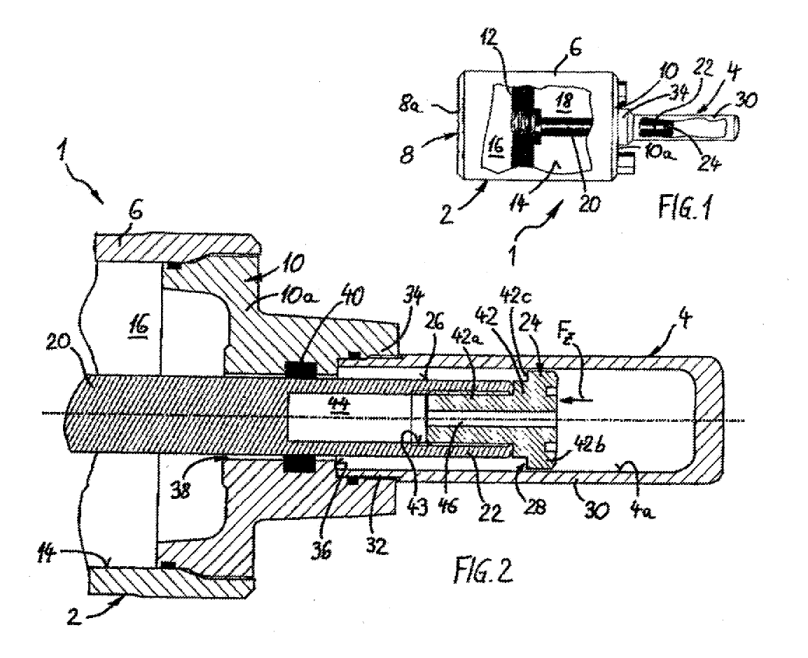

A hydropneumatic piston reservoir 1 pursuant to the invention according to FIG. 1 consists of a primary cylinder 2 and a secondary cylinder 4. The primary cylinder 2 has a cylindrical circumferential wall 6 and two ends 8 and 10 that are preferably designed as separate caps 8a and 10a, and in particular are screwed down pressure-tight to the circumferential wall 6. A “floating” and freely movable separating piston 12 is guided in the primary cylinder and is sealed circumferentially against an inner surface 14 of the circumferential wall 6. The separating piston 12 thereby separates two pressure chambers 16 and 18 in the primary cylinder from one another, which are acted upon or can be acted upon on the one hand by a pneumatic pressure medium and on the other hand by a hydraulic medium. The separating piston 12 is connected on one side to a central separating piston rod 20 extending axially, i.e. in the direction of an axis of motion of the separating piston 12, which is sealed off circumferentially from the primary cylinder 2 and is guided as a plunger 22 in the axially connected secondary cylinder 4. An added force F_{z} acting through the plunger 22 in the direction of the separating piston 12 is produced by impacting the secondary cylinder 4 with a pressure medium.

As also seen in FIG. 2, the plunger 22 pursuant to the invention has a bumper element 24 at its free end away from the primary cylinder 2, with a bumper area 28 projecting beyond the cylindrical outer circumference 26 of the plunger 22. This bumper element 24 beneficially prevents the plunger 22 from being able to leave the secondary cylinder 4 toward the primary cylinder 2 after assembly of the piston reservoir 1 pursuant to the invention. It is thus a “catcher” to prevent reliably the entire separating piston 12 from being shot out of the piston reservoir with its separating piston rod 20 along with the plunger 22 in case the cap end 8 is detached or fails by overpressure.

From the structural viewpoint, for assembly of the piston reservoir 1, the secondary cylinder 4 may be formed by a tube 30 closed at one end, with this tube 30 being screwed down pressure-tight by a thread 32 at its open end to a threaded connector 34 of the face 10 or of the cap 10a of the primary cylinder 2 screwed to the circumferential wall 6. The threaded connector 34 with a radial annular surface 36 forms a bumper for the bumper element 24 of the plunger 22. The threaded connector 34 also forms a passage 38 for the separating piston rod 20, with at least one circumferential gasket 40 for the separating piston rod 20 being positioned in the passage 38. This circumferential gasket 40 seals the annular gap between the separating piston rod 20 and the passage 38 pressure-tight, so that different pressures can prevail inside the secondary cylinder 4 and inside the adjacent pressure chamber 16 of the primary cylinder 2.

For purposes of assembly, it is also possible to form the bumper element 24 by a screw 42 that engages with a threaded shaft 42a in an axial internal thread 43 of the plunger 22, and that has a head 42b enlarged in diameter compared to the plunger 22, with the head 42b on its side facing the threaded shaft 42a having a radial annular surface 42c constituting the bumper area 28.

The piston reservoir 1 can be assembled as follows. First, with the forward end 8 (cap 8a) still open, the separating piston 12 is inserted in the primary cylinder 2 with the separating piston rod 20 in front. The separating piston rod 20—still without the bumper element 24 pursuant to the invention—is thus passed through the passage 38 and the seal 40 to the outside. The primary cylinder 2 can then be closed with the end 8 (the cap 8a), for which a threaded connection is preferably provided, for example such as a screw cap. The screw 42 constituting the bumper element 24 can then be assembled at the end of the separating piston rod 20 and screwed tight still freely extending to the outside and constituting the plunger 22. Finally, the tube 30 constituting the secondary cylinder 4 is fed by its open end over the plunger 22, and is screwed securely with its thread 32 to the threaded connector 34. Finally the pressure can be applied.

To do this, a pressure medium, pneumatic in particular, is applied to the secondary cylinder 4 through a filling connector. It is preferred to use nitrogen gas. Of course the application of a hydraulic medium is within the scope of the invention.

A hydraulic medium is applied through a line connector to the first pressure chamber 16 of the primary cylinder 2 encircling the separating piston rod 20 as an annular chamber. As a general rule, the first pressure chamber 16 is connected hydraulically to a shock absorber leg (telescopic spring cylinder) of a motor vehicle suspension system (not shown).

The second pressure chamber 18 opposite the separating piston rod 20 as a cylindrical chamber is exposed to a pneumatic pressure medium, particularly including nitrogen gas, through a filling connector.

For completeness, it should also be mentioned that the plunger 22 including the bumper element 24 is positioned as a frictionless “plunger” in the secondary cylinder, with radial circumferential spacing (i.e. non sealing) from the inside wall 4a of the cylinder.

In a particularly beneficial embodiment of the invention shown in FIG. 2, the plunger 22 has a cavity that constitutes a compensation chamber 44 that is connected through an axial passage channel 46 of the bumper element 24 to the inner chamber of the secondary cylinder 4. The compensation chamber 44 here is designed to match the bumper element 24 in such a way that its volume corresponds at least approximately to the volume of the bumper element 24 crucial for displacing the pressure medium. The inner volume of the secondary cylinder can thereby be kept largely constant despite the bumper element 24 additionally placed in the internal chamber, which also applies correspondingly to the pressure and compression characteristic (spring characteristic) of the pressure medium.

The invention is not limited to the illustrated and described sample embodiments, but also includes all equivalent implementations in the meaning of the invention. It is expressly noted that the sample embodiments are not limited to all features in combination, but instead each individual sub-feature separately from all other sub-features can have inventive significance by itself.

While the above description constitutes the preferred embodiment of the present invention, it will be appreciated that the invention is susceptible to modification, variation, and change without departing from the proper scope and fair meaning of the accompanying claims.

1. A hydropneumatic piston reservoir (1) comprising a primary cylinder (2) in which runs a separating piston (12) with free mobility, wherein the separating piston (12) is sealed off circumferentially by the separating piston (12) inside the primary cylinder (2) separating first and second pressure chambers (16, 18) from one another, and with the separating piston (12) having an axial separating piston rod (20) at one end that is sealed off circumferentially from the primary cylinder (2) and is guided as a plunger (22) in a following secondary cylinder (4) and is subjected to or adapted to be subjected to a pressure medium, the plunger (22) at its free end away from the primary cylinder (2) having a bumper element (24) with a bumper area (28) projecting radially over the outer circumference (26) of the plunger (22) and having a surface (36) engageable with the bumper element.

2. A piston reservoir pursuant to claim 1, further comprising in that the plunger (22) including the bumper element (24) is placed inside the secondary cylinder (4) with a radial circumferential clearance from the inside wall of the cylinder.

3. A piston reservoir pursuant to claim 1, further comprising in that the bumper element (24) is composed of a screw (42) with a threaded shaft (42a) that engages with an axial internal thread (43) of the plunger (22), and that has a head (42b) enlarged in diameter compared to the plunger (22) with the head (42b) having an annular surface (42c) on its side facing the threaded shaft (42a) that constitutes the bumper area (28).

4. A piston reservoir pursuant to claim 1, further comprising in that the plunger (22) has a cavity that forms a compensation chamber (44) connected to the internal chamber of the secondary cylinder (4) through an axial passage channel (46) of the bumper element (24), whose volume corresponds at least approximately to the volume of the bumper element (24).

5. A piston reservoir pursuant to claim 1, further comprising in that the secondary cylinder (4) is composed of a tube (30) closed at one end that is screwed pressure-tight to a threaded connector (34) of the primary cylinder (2) by a thread (32).

6. A piston reservoir pursuant to claim 5, further comprising in that the threaded connector (34) with a radial annular surface (36) forms the surface for engaging for the bumper element (24).

7. A piston reservoir pursuant to claim 1, further comprising in that the separating piston rod (2) is guided through a cylinder passage (38) and at least one circumferential gasket (40) is placed in the area of the passage (38).

8. A piston reservoir pursuant to claim 1, further comprising in that the secondary cylinder (4) is subjected to or can be subjected to a pneumatic pressure medium including nitrogen gas.

9. A piston reservoir pursuant to claim 1, further comprising in that the first pressure chamber (16) of the primary cylinder (2) encircling the separating piston rod (20) as an annular chamber is subjected to or can be subjected to a hydraulic medium.

10. A piston reservoir pursuant to claim 1, further comprising in that the second pressure chamber (18) of the primary cylinder (2) opposite the separating piston rod (10) as a cylindrical chamber is subjected to or can be subjected to a pneumatic pressure medium including nitrogen gas.
